(19) United States
(12) Patent Application Publication
(10) Pub. No.: US 2025/0023412 A1
(43) Pub. Date: Jan. 16, 2025

(54) ROTOR ASSEMBLY FOR AN ELECTRIC MACHINE, ELECTRIC MACHINE COMPRISING THE ROTOR ASSEMBLY, AND VEHICLE COMPRISING THE ELECTRIC MACHINE

(71) Applicant: ZF FRIEDRICHSHAFEN AG, Friedrichshafen (DE)

(72) Inventor: Sven HOLST, Meckenbeuren (DE)

(21) Appl. No.: 18/712,098

(22) PCT Filed: Nov. 23, 2022
(86) PCT No.: PCT/EP2022/082888

§ 371 Date: May 21, 2024

(30) Foreign Application Priority Data
Nov. 25, 2021 (DE) 10 2021 213 255.3

(51) Int. Cl. H02K 1/32

(52) U.S. Cl. CPC H02K 1/32

(57) ABSTRACT

An electric machine having a rotor assembly with a hollow shaft rotatable about a rotational axis and a rotor element. The rotor element is coaxial to the hollow shaft and rotates with the hollow shaft. Contact and spacing regions are formed in the circumferential direction between the outer circumference of the hollow shaft and the inner circumference of the rotor element. The rotor element is arranged to contact the hollow shaft in the contact regions and be at a distance in the spacing regions. A conducting tube is arranged in a cavity of the hollow shaft coaxial to the hollow shaft and to the rotor element. The cooling fluid can flow out of the conducting tube along a first flow path and along a second flow path to cool the components of the electric machine.

### CROSS REFERENCE TO RELATED APPLICATIONS

This is a U.S. national stage of Application No. PCT/EP2022/082888 filed Nov. 23, 2022. Priority is claimed on German Application No. DE 10 2021 213 255.3 filed Nov. 25, 2021, the content of which is incorporated herein by reference.

### BACKGROUND OF THE INVENTION

### 1. Field of the Invention

The disclosure concerns a rotor assembly for an electric machine and an electric machine with the rotor assembly and a vehicle with the electric machine.

### 2. Description of the Related Art

Electric motors in which the rotor shaft has a non-circular cross-section are already known from the prior art. For example, publication DE 10 2018 122 977 A1 describes a shaft arrangement with a hollow shaft rotatable about a rotational axis and with a hub body, wherein the hollow shaft is connected by force fit to the hub body. Distributed over its periphery, the hollow shaft has several support portions in which it is in contact with the hub body and several spring portions that are spaced from an inner circumferential face of the hub body.

Also known are electric motors having hollow shafts with a flow channel arranged in the cavity, through which a hydraulic fluid can be conducted for cooling components of the electric motor. For example, publication DE 10 2018 200 865 A1 describes a rotor for an electric machine that has a rotor shaft, wherein a centering element is arranged in the cavity of the rotor shaft and may form a cooling channel for conduction of cooling fluid and for introduction of cooling fluid into the cavity.

### SUMMARY OF THE INVENTION

One aspect of the present invention provides a functionally improved cooling of components of an electric machine.

A rotor assembly is provided for an electric machine, in particular an electric motor. The electric machine may be integrated in a vehicle, e.g. a car or truck, for driving a drive axle. Preferably, the electric machine may form part of an electric axle, in particular a so-called E-axle of the vehicle.

The rotor assembly has a hollow shaft that can rotate about a rotational axis. Preferably, the rotational axis defines an axial direction. Preferably, the rotor assembly comprises a first end flange and a second end flange, by which the hollow shaft is mounted rotatably about the rotational axis. For example, one of the end flanges has a hollow cylindrical portion.

The rotor assembly comprises a rotor element, which is preferably annular in cross-section. The rotor element is coaxial to and surrounds the hollow shaft. Optionally, the rotor element is connected to the hollow shaft by form fit and/or force fit, in particular by a press fit. The rotor element can thus rotate together with the hollow shaft about the rotational axis. Preferably, coils, also called armatures, for generating a magnetic field are arranged on both axial rotor end faces of the rotor element. The coils are described below as first and second end windings. The rotor element with the end windings preferably cooperates with a stator of the electric machine, which can generate a further magnetic field, whereby the rotor assembly can be brought to rotate about the rotational axis. Optionally, the rotor assembly may also comprise balancing discs and/or short-circuit rings, which are arranged coaxially adjacent to the rotor element.

Contact regions and spacing regions are formed in the circumferential direction about the rotational axis between the outer periphery of the hollow shaft and an inner periphery of the rotor element. In the contact regions, the rotor element is in contact with the hollow shaft. In particular, the form-fit and/or force-fit connection between the rotor element and the hollow shaft, in particular the press fit, is formed in the contact regions. In the spacing regions, the rotor element is spaced from the hollow shaft. In particular, gaps are formed between the hollow shaft and the rotor element in the spacing regions.

To form the contact regions and spacing regions, the hollow shaft is for example angular and/or polygonal in cross-section, or configured to be substantially angular and/or polygonal. Optionally, corners of the hollow shaft may have a radius and/or radius development, in particular be curved and/or rounded.

According to one aspect of the invention, it is provided that the rotor assembly comprises a conduction tube which is configured for conducting a cooling fluid. The conduction tube is arranged in a cavity of the hollow shaft so as to be coaxial thereto and to the rotor element. Preferably, the conduction tube is rotationally fixedly connected to the hollow shaft by the end flanges, so that in particular it can rotate together with the hollow shaft and rotor element about the rotational axis. Preferably, the hollow cylindrical portion is fluidically connected to the conduction tube. It is advantageous that cooling fluid can be introduced into the conduction tube, e.g. through the hollow cylindrical portion, and there distributed to various components of the rotor assembly in order to cool these during operation of the electric machine.

In a preferred aspect of the invention, the cooling fluid can be introduced into the conduction tube, preferably in an axial direction relative to the rotational axis. Optionally, the cooling fluid may be introduced through the hollow cylindrical portion of the at least one end flange into the conduction tube. Preferably, the conduction tube can discharge the cooling fluid to flow along a first flow path and to flow along a second flow path. For example, the first flow path and the second flow path are arranged radially offset to one another relative to the rotational axis. Optionally in addition, the conduction tube may discharge the cooling fluid to flow along a third flow path.

For example, the first flow path extends through the cavity of the hollow shaft and over at least one rotor end face and/or end face regions of the rotor element. Optionally, the first flow path runs over the at least one rotor end face to the balancing discs, short-circuit rings and/or end windings arranged on the end face. The second flow path extends preferably through the spacing regions between the hollow shaft and the rotor element and over at least one rotor end face, and/or over the end face regions of the rotor element. It is possible that the second flow path runs over the at least one rotor end face to the balancing discs, short-circuit rings and/or end windings. The third flow path extends for example out of the conduction tube to the at least one rotor end face and/or over the end face regions of the rotor element. Optionally, the third flow path extends from there to the balancing discs, short-circuit rings, and/or end windings.

In a further preferred aspect of the invention, the conduction tube has at least one tube opening through which the cooling fluid can escape into the cavity of the hollow shaft. The tube opening may be made in an axial end region of the conduction tube or in a central and/or middle region of the conduction tube. Because the cooling fluid can escape into the cavity, it builds up there for a time and can thus absorb heat generated during operation from the contact faces between the rotor element and the hollow shaft.

In possible structural aspect of the invention, the hollow shaft has at least one shaft outflow opening, in particular at its axial end regions. For flowing along the first flow path, the cooling fluid can flow through the at least one shaft outflow opening out of the cavity and to at least one rotor end face. Alternatively or optionally in addition to the shaft outflow opening, at least one of the end flanges may have a flange outflow opening. For flow of cooling fluid along the first flow path, the cooling fluid can flow through the flange outflow opening out of the cavity to at least one of the rotor end faces.

In a further aspect of the invention, one of the end flanges has an output opening. Preferably, for flowing along the second flow path, the cooling fluid can be conducted through the output opening into the spacing regions. Optionally in addition, the end flange having the output opening has a further flange outflow opening. Preferably, part of the fluid volume of the cooling fluid conducted through the conduction tube can flow along the first flow path, and another part of the fluid volume can escape through the further flange outflow opening, in particular along the third flow path, to the assigned rotor end face.

Preferably, the other end flange has an outlet opening. Within the second flow path, the cooling fluid preferably flows from the spacing regions to the outlet opening, wherein the flow is directed in particular in the axial direction or in a counter direction. In particular, for flow along the second flow path, the cooling fluid can escape through the outlet opening to at least one of the rotor end faces. It is advantageous that the fluid in the spacing regions can directly absorb the heat generated during operation of the electric machine, and on emerging from the outlet opening, dissipate this from the rotor assembly.

Optionally, the hollow cylindrical portion of the first end flange and/or second end flange has a stepped internal diameter with a first step and a second step. Preferably, the first step has a first inner diameter and the second step has a second inner diameter. Preferably, the first inner diameter is arranged on the conduction tube side and/or in front of the second inner diameter in the axial direction. In particular, the first inner diameter is smaller than the second inner diameter. For example, the outlet opening is made in the first step and the further flange outflow opening is made in the second step. It is advantageous that by the stepped internal diameter, part of the fluid volume introduced into the conduction tube can already be distributed to the outlet opening and another part to the further flange outflow opening, and hence the fluid volume can be distributed to the different flow paths in targeted fashion. In particular, by matching the steps of the stepped inner diameter, simple adaptation to different applications with respect to machine type and/or size is possible.

In an aspect of the invention, the rotor assembly has a fluid distribution adapter with an integral catchment channel in which multiple adapter openings are made, for example with a first adapter opening, a second adapter opening and optionally in addition a third adapter opening. Optionally, the first adapter opening is oriented radially. The second adapter opening is e.g. directed in the axial direction, wherein the third adapter opening is directed optionally in the counter direction.

Preferably, the fluid distribution adapter is configured to direct a part of the fluid volume to flow along the first flow path and to flow along the second flow path. For example, the fluid distribution adapter is arranged coaxially to the conduction tube, wherein it sits rotationally fixedly on the conduction tube within the cavity of the hollow shaft and bears on an inner diameter of the hollow shaft, for example by interference fit. Preferably, the fluid distribution adapter is arranged on the tube opening of the conduction tube. Thus the cooling fluid can flow from the conduction tube through the tube opening into the catchment channel. Preferably, the fluid distribution adapter lies against the shaft bore.

In a further aspect of the invention, for the flow of cooling fluid along the second flow path, the first adapter opening forms a fluidic connection between the conduction tube and the spacing regions. In particular, a part of the fluid volume for flowing along the second flow path can escape from the catchment channel through the first adapter opening and flow through the shaft bore into the spacing regions.

Preferably, for the flow of cooling fluid along the first flow path, the second and/or third adapter opening forms a fluidic connection between the conduction tube and the cavity of the hollow shaft. In particular, for flowing along the first flow path, another part of the fluid volume can flow through the second and/or third adapter opening into the cavity of the hollow shaft.

To regulate the fluid volume, the shaft bore may have a different, in particular smaller diameter than the first adapter opening. Thus during operation of the electric machine, in particular with a rotating rotor assembly, it can be achieved that the fluid arranged in the catchment channel builds up and is conducted through the second and/or third adapter opening into the cavity of the hollow shaft.

A further aspect of the invention is an electric machine with the rotor assembly presented in the description above. To generate a magnetic field, the rotor assembly preferably has a first end winding and a second end winding, wherein the first end winding is arranged on the first rotor end face and wherein the second end winding is arranged on the second rotor end face.

Preferably, the electric machine has a first collection container in which cooling fluid can be collected and distributed to the end windings. In particular, the electric machine has an axially extending flow channel through which the cooling fluid can be introduced into the collection container. Particularly preferably, it lies within the scope of the invention that the flow channel is arranged radially outside the rotor assembly, in particular radially outside the stator. Preferably, the collection container has multiple container openings through which the cooling fluid can flow onto the end windings. In particular in operating states of the electric machine with low rotation speeds associated with high loads and hence high heat development, cooling of the end windings by the flow channel and collection container is particularly advantageous.

A further aspect of the invention is a vehicle, in particular a purely electric or hybrid vehicle, with the electric machine presented in the description above.

### BRIEF DESCRIPTION OF THE DRAWINGS

Further features, advantages and effects of the invention arise in the following description of preferred exemplary embodiments of the invention. In the drawing:

FIG. 1 is an axial longitudinal section through an electric machine with a rotor assembly and a stator;

FIG. 2 is a cross-section through the rotor assembly;

FIG. 3 is an enlarged illustration of a flow channel and a collection container of the electric machine;

FIG. 4 is a cross-section through the flow channel and the collection container;

FIG. 5 is an axial longitudinal section through the electric machine, wherein the rotor assembly comprises a fluid distribution adapter;

FIG. 6 is a cross-section through the rotor assembly 1 with the fluid distribution adapter; and

FIG. 7 is a perspective plan view of the fluid distribution adapter.

Corresponding or identical parts carry the same reference sign in the figures.

### DETAILED DESCRIPTION OF THE PRESENTLY PREFERRED EMBODIMENTS

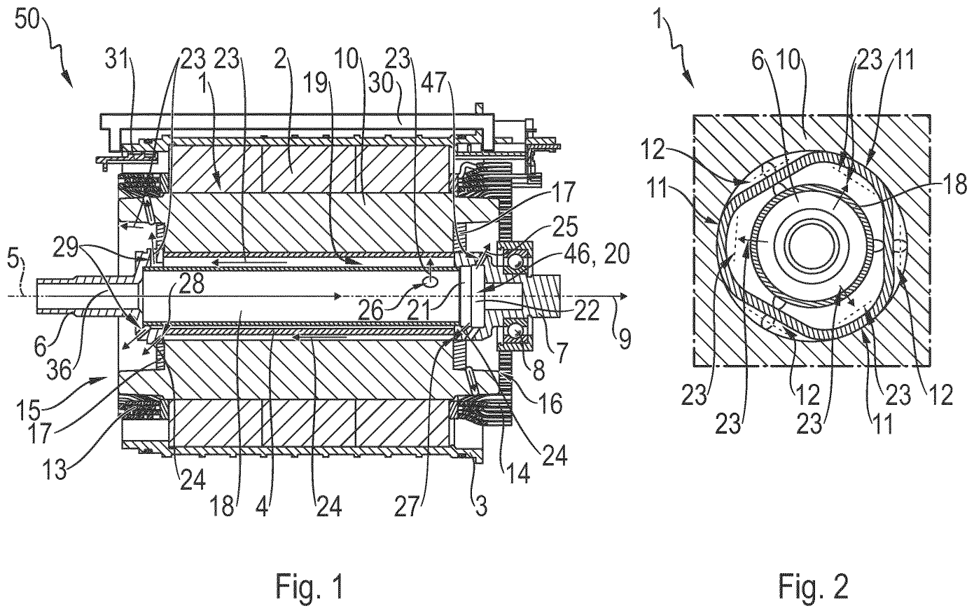

FIG. 1 shows an axial longitudinal section through an electric machine 50. The electric machine 50 comprises a rotor assembly 1 rotatable about a rotational axis 5, and a stator 2, wherein the rotor assembly 1 and the stator 2 are arranged coaxially to one another relative to the rotational axis 5. The stator 2 is arranged radially outside and/or surrounds the rotor assembly 1. The rotor assembly 1 and the stator 2 are received in a housing 3 of the electric machine 50. The rotational axis 5 defines an axial direction 9.

The rotor assembly 1 comprises a hollow shaft 4 which is mounted on at least one roller bearing 8 so as to be rotatable about the rotational axis 5 by a first end flange 6 and a second end flange 7. For this, the first end flange 6 is rotationally fixedly connected to a first axial end of the hollow shaft 4, and the second end flange 7 is rotationally fixedly connected to a second axial end of the hollow shaft 4. The first end flange 6 has a first hollow cylindrical portion 36 which is open in a counter direction to the axial direction 9. The second end flange 7 has a second hollow cylindrical portion 46 which is closed in the axial direction 9. The second hollow cylindrical portion 46 has a stepped inner diameter 20 with steps 21, 22 arranged successively in the axial direction 9. A first step 21 has a smaller inner diameter than a second step 22.

The rotor assembly 1 comprises a rotor element 10 arranged coaxially to the hollow shaft 4. According to FIG. 2, which shows a cross-section through the rotor assembly 1, the rotor element 10 is configured as a circular ring in cross-section. The hollow shaft 4 has a substantially polygonal, in particular hexagonal outer contour, wherein the corners of the hollow shaft 4 have a radius and/or a radius development.

The rotor element 10 sits on the hollow shaft 4, wherein multiple, e.g. three contact regions 11, and multiple e.g. three spacing regions 12 are formed between an inner periphery of the rotor element 10 and an outer periphery of the hollow shaft 4. In the contact regions 11, the rotor element 10 is rotationally fixedly connected to the hollow shaft 4 by a press fit, so that the rotor element 10 can rotate together with the hollow shaft 4 about the rotational axis 5.

With reference to FIG. 1, the rotor assembly 1 has a first end winding 13 and a second end winding 14, wherein the first end winding 13 is arranged on a first rotor end face 15 and the second end winding 14 is arranged on a second rotor end face 16, in particular wound onto end face regions of the rotor element. Axially adjacent to the axial rotor end faces 15, 16, balancing discs and/or short-circuit rings 17 are arranged coaxially to the main axis 5.

The rotor assembly 1 comprises a conduction tube 18 for conduction and distribution of a cooling fluid provided for cooling components of the electric machine 50, in particular the rotor assembly 1. The conduction tube 18 is arranged in a cavity 19 of the hollow shaft 4 and is coaxial thereto, wherein it is held at the ends by the end flanges 6, 7 and thereby rotationally fixedly connected to the hollow shaft. The hollow cylindrical portion 36 of the first end flange 6 opens into the conduction tube 18 so that this can be filled with cooling fluid via the first end flange 6.

The conduction tube 18 is configured to discharge the cooling fluid to flow along a first flow path 23, to flow along a second flow path 24 and to flow along a third flow path 25.

The first flow path 23 extends through the cavity 19 of the hollow shaft 4 and over the first rotor end face 15 and/or over an end region of the rotor element 10 adjoining the first rotor end face 15. For discharging cooling fluid into the first flow path 23, the conduction tube 18 has at least one, e.g. two or four tube openings 26 which are made in an end region of the conduction tube 18 adjacent to the second end flange 7. The cooling fluid introduced into the conduction tube 18 emerges from the two openings 26 and flows into the cavity 19 of the hollow shaft 4, wherein it flows in the axial counter direction and hence absorbs heat generated in operation of the electric machine 50 between the hollow shaft 4 and the rotor element 10. To output the cooling fluid from the cavity 19 along the first flow path, the first end flange 6 has multiple e.g. two or four flange outflow openings 29 through which cooling fluid can escape from the hollow shaft 4 and be flung onto the first rotor end face 15 and/or the end face region by the rotation of the rotor assembly 1. From there, the cooling fluid can flow to the balancing discs and/or short-circuit rings 17 arranged there and to the first end winding 13.

The second flow path 24 extends through the spacing regions 12 between the hollow shaft 4 and the rotor element 10, over the first rotor end face 15 and/or the end region of the rotor element 10 adjoining this. Thus the first flow path 23 and the second flow path 24 are arranged radially offset to one another relative to the rotational axis 5. For discharging the cooling fluid into the second flow path 24, the conduction tube 18 is fluidically connected to the second hollow cylindrical portion 46 of the second end flange 7. This has an output opening 27 arranged in the first step 21 of the stepped inner diameter 20. The cooling fluid can escape through the output opening 27 into the spacing regions 12. In the spacing regions 12, the cooling fluid flows in the axial counter direction and thus directly absorbs the heat generated by rotation of the rotor element 10 and the hollow shaft 4. For outlet of the cooling fluid from the spacing regions 12 along the second flow path 24, the first end flange 6 has at least one outlet opening 28. The cooling fluid can escape through the outlet opening 28 and is flung onto the first rotor end face 15 and/or the end face region by rotation of the rotor assembly 1. From there, the cooling fluid can flow to the balancing discs and/or short-circuit rings 17 arranged there and to the first end winding 13.

The third flow path 25 extends from the conduction tube 18 to the second rotor end face 16 and/or to the end region of the rotor element 10 adjoining this. From there, the third flow path 25 runs to the balancing discs and/or short-circuit rings 17 arranged adjacent to the rotor end face 16 and to the second end winding 14. To discharge the cooling fluid into the third flow path 25, the second hollow cylindrical portion 46 of the second end flange 7, fluidically connected to the conduction tube 18, has a further flange flow opening 47. The further flange outflow opening 47 is made in the second step 22 of the stepped inner diameter 20. For flowing along the third flow path 25, the cooling fluid can flow out of the further flange outflow opening 47 and is flung onto the second rotor end face 16 and/or the end region of the rotor element 10 adjoining this by the rotation of the rotor assembly 1. From there, the cooling fluid can flow to the balancing discs and/or short-circuit rings 17 arranged there and to the second end winding 14. It is also possible that the roller bearing 8 can be cooled by the outflung cooling fluid.

Because of the stepped inner diameter 20 and the arrangement of the output opening 27 in the first step 21, or the arrangement of the further flange outflow opening 27 in the second step 22, a fluid volume of the cooling fluid can be divided in targeted fashion into the three flow paths 23, 24, 25.

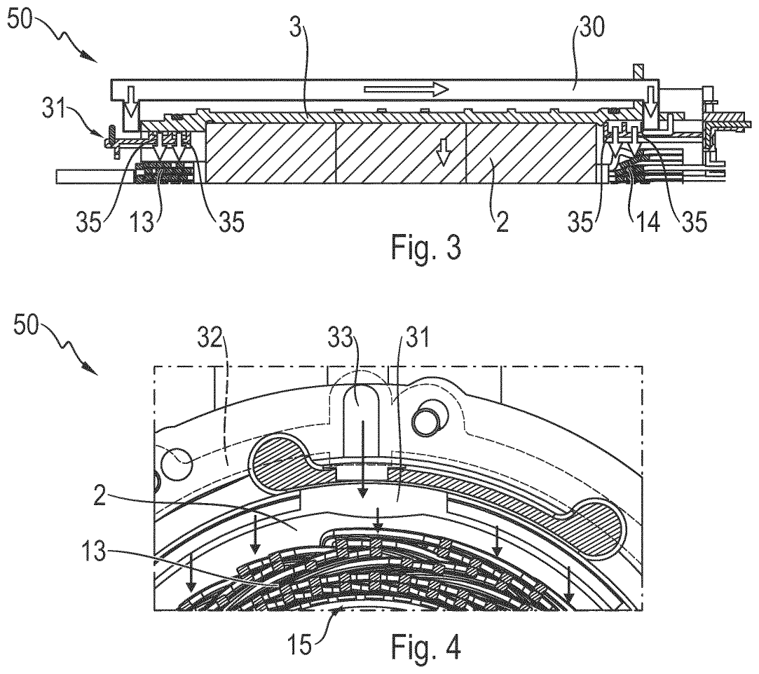

The electric machine 50 has a flow channel 30 for conduction of the cooling fluid and a collection container 31 for collection of cooling fluid. The flow channel 30 and the collection container 31 are shown in enlarged axial longitudinal section in FIG. 3, and in axial cross-section in FIG. 4.

The flow channel 30 is arranged radially outside the housing 3 and extends in the axial direction 9. The housing 3 has an axial longitudinal bore 32 and two radial bores 33, via which it is fluidically connected to the flow channel 30. The cooling fluid can flow to the stator 2 and into the collection container 31 through the longitudinal bore 32 and the radial bores 33. Multiple e.g. two container openings 35 are made in the collection container 31, through which the cooling fluid can flow directly onto the end windings 13, 14 for cooling. The stator 2 and end windings 13, 14 can thus be cooled in addition to the cooling via the three flow paths 23, 24, 25. In particular in operation of the electric machine 50 at low rotation speeds and high loads, adequate cooling of the components can thus be provided.

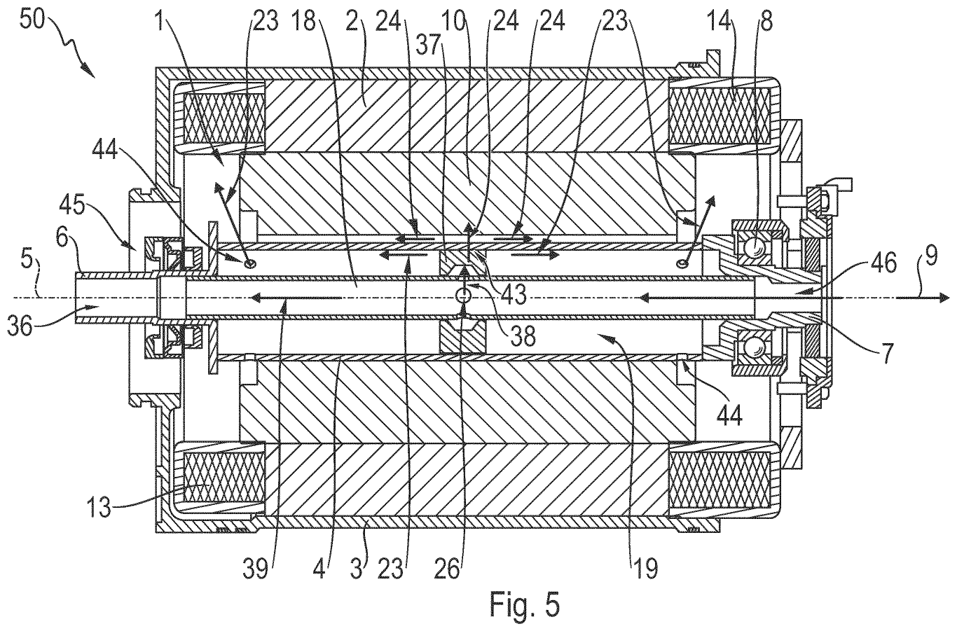

FIG. 5 shows an axial longitudinal section through the electric machine 50 with the rotor assembly 1, stator 2 and housing 3. The two hollow cylindrical portions 36, 46 of the end flanges 6, 7 are open in the axial direction 9 and in the counter direction. The cooling fluid can thus be introduced through the second end flange 7 in the axial counter direction into the conduction tube 18 so that it flows along the conduction tube.

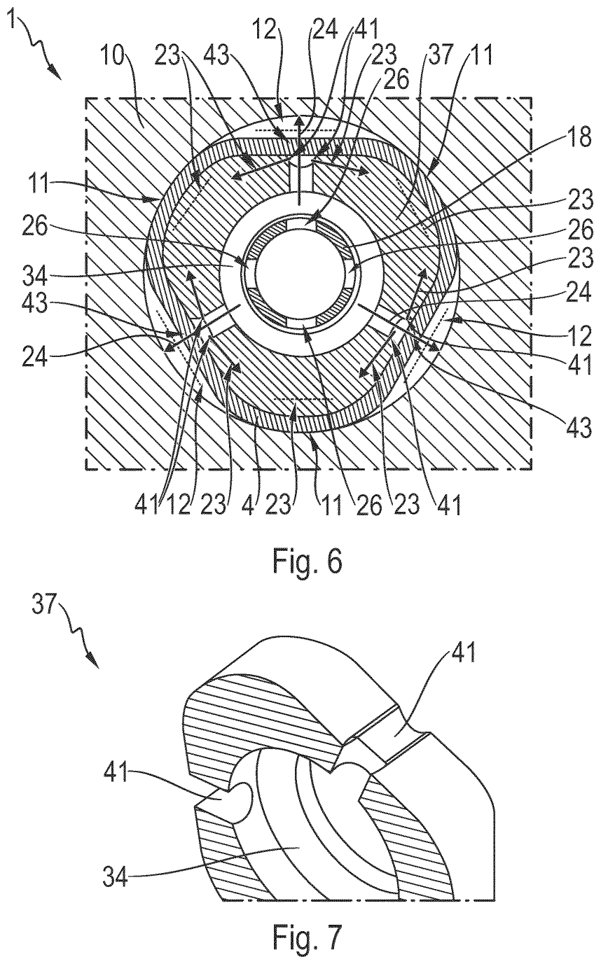

The rotor assembly 1 comprises a fluid distribution adapter 37 which can distribute the cooling fluid introduced into the conduction tube 18 onto the first flow path 23 and the second flow path 24. The rotor assembly 1 with the fluid distribution adapter 37 is shown in axial cross-section in FIG. 6. FIG. 7 shows the fluid distribution adapter 37 in a perspective plan view.

Viewed in conjunction with FIG. 5, the fluid distribution adapter 37 is formed substantially annular and is arranged in the cavity 19 of the hollow shaft 4. The fluid distribution adapter 37 sits centrally on the conduction tube 18, wherein it is rotationally fixedly connected to the conduction tube. The fluid distribution adapter 37 has an integral catchment channel 34 in which a first part volume 38 of the cooling fluid can be captured and distributed. A second part volume 39 flows along the conduction tube 18 in the axial counter direction and emerges from the first end flange 6. A gear mechanism 45 (see FIG. 5) arranged on the first end flange 6 can be cooled thereby.

In contrast to FIG. 1, the tube openings 26 are arranged centrally in the conduction tube 18. They open into the catchment channel 34 so that a first part volume 38 can flow therein. The hollow shaft 4 has at least one, e.g. two or four, centrally arranged shaft bores 43.

The fluid distribution adapter 37 has at least one first radially oriented adapter opening 40, e.g. four first adapter openings 40. A part of the cooling fluid collected in the catchment channel 34 can escape through the first adapter openings 40, through the central shaft bores 43, into the spacing regions 12 for flowing along the second flow path 24. In the spacing regions 12, the fluid flows in the axial direction 9 and in the counter direction, and can emerge at the rotor end faces 15, 16 in order to cool these, the balancing discs and/or short-circuit rings 17 and end windings 13, 14.

The fluid distribution adapter 37 has at least one, e.g. four axially oriented second adapter openings 41. Through the second adapter openings 41, the other part of the cooling fluid collected in the catchment channel 34 can escape to flow along the first flow path 23 into the cavity 19 of the hollow shaft 4.

To regulate the proportions of the fluid volume which flow through the shaft bores 43 into the spacing regions 12 and through the second adapter openings 41 into the cavity 19, the shaft bores 43 have smaller diameters than the first adapter openings 40. Because of the reduced diameter of the shaft bores 43 compared with the first adapter openings 40, the cooling fluid builds up in the catchment channel 34 so that the other part of the cooling fluid can emerge axially from the second adapter openings 41 despite the rotation of the rotor assembly 1. Despite the reduced diameter of the shaft bores 43, under centrifugal force a greater fluid volume is introduced into the spacing regions 12 than into the cavity 19.

At each of its two axial end regions, in particular adjacent to the two and flanges 6, 7, the hollow shaft 4 has multiple e.g. two or four shaft outflow openings 44. For conduction along the first flow path 23, the cooling fluid can flow through the outflow openings 44 out of the cavity 19 and be flung onto the rotor end faces 15, 16, the end face regions of the rotor element 10, the balancing discs and/or short-circuit rings 17, and the end windings 13, 14. It is also possible that the roller bearing 8 can be cooled by the outflung cooling fluid.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A rotor assembly for an electric machine, comprising:
a hollow shaft which is rotatable about a rotational axis;
a rotor element coaxial to and surrounding the hollow shaft, wherein the rotor element rotates and/or can rotate together with the hollow shaft;
contact regions and spacing regions formed in a circumferential direction about a rotational axis between an outer periphery of the hollow shaft and an inner periphery of the rotor element,
wherein the rotor element is arranged to contact the hollow shaft in the contact regions and be spaced from the hollow shaft in the spacing regions; and
a conduction tube arranged in a cavity of the hollow shaft to be coaxial to the hollow shaft and to the rotor element and configured to conduct a cooling fluid.

17. The rotor assembly as claimed in claim 1,
wherein the cooling fluid is introduced into the conduction tube in an axial direction relative to the rotational axis,
wherein the conduction tube is configured to discharge the cooling fluid to flow along a first flow path and to flow along a second flow path, and
wherein the first flow path and the second flow path are arranged radially offset to one another relative to the rotational axis.

18. The rotor assembly as claimed in claim 17, wherein the first flow path extends through the cavity of the hollow shaft and over at least one rotor end face of the rotor element, and that the second flow path extends through the spacing regions between the hollow shaft and the rotor element and over the at least one rotor end face.

19. The rotor assembly as claimed in claim 17, wherein for a flow of cooling fluid along the first flow path, the conduction tube has a tube opening through which the cooling fluid can escape into the cavity of the hollow shaft.

20. The rotor assembly as claimed in claim 19, wherein for a flow of cooling fluid along the first flow path, the hollow shaft has at least one shaft outflow opening through which the cooling fluid flows out of the cavity to at least one rotor end face.

21. The rotor assembly as claimed in claim 17,
wherein the rotor assembly has a first end flange and a second end flange for rotatable mounting of the hollow shaft,
wherein the conduction tube is rotationally fixedly connected to the hollow shaft by the first and second end flanges,
wherein at least one of the first and second end flanges has a hollow cylindrical portion which is fluidically connected to the conduction tube, and
wherein the cooling fluid is conducted through the hollow cylindrical portion into the conduction tube.

22. The rotor assembly as claimed in claim 21, wherein for flow of cooling fluid along the first flow path, at least one of the first and second end flanges has at least one flange outflow opening, through which the cooling fluid can flow out of the cavity to at least one rotor end face.

23. The rotor assembly as claimed in claim 21, wherein for flow of cooling fluid along the second flow path, one of the first and second end flanges has an output opening, through which the cooling fluid can be output into the spacing regions, and/or that for the flow of cooling fluid along the second flow path, the hollow shaft has at least one shaft bore through which the cooling fluid can flow into the spacing regions.

24. The rotor assembly as claimed in claim 23, wherein for flow of cooling fluid along the second flow path, the other of the first and second end flange has an outlet opening, through which the cooling fluid can be expelled from the spacing regions to a rotor end face and/or that the cooling fluid can flow directly out of the spacing regions to at least one of the rotor end faces.

25. The rotor assembly as claimed in claim 24, wherein for fluid volume division, the hollow cylindrical portion of the at least one of the end flanges has a stepped internal diameter with a first step and a second step, wherein the outlet opening is made in one of the steps and wherein a further flange outflow opening is made in the other step, through which opening the cooling fluid can flow out of the conduction tube along a third flow path to at least one rotor end face.

26. The rotor assembly as claimed in claim 17, wherein the rotor assembly has a fluid distribution adapter for distribution of cooling fluid into the first flow path and into the second flow path, wherein the fluid distribution adapter is arranged coaxially with the conduction tube and is rotationally fixedly on the conduction tube within the cavity of the hollow shaft.

27. The rotor assembly as claimed in claim 26,
wherein the fluid distribution adapter has multiple adapter openings,
wherein for the flow of cooling fluid along the first flow path, at least one adapter opening forms a fluidic connection between the conduction tube and the cavity of the hollow shaft, and/or
wherein for the flow of cooling fluid along the second flow path, at least one further adapter opening forms a fluidic connection between the conduction tube and the spacing regions,
wherein to control a fluid volume of the cooling fluid, a shaft bore in the hollow shaft has a smaller diameter than the first adapter opening.

28. An electric machine comprising:
a rotor assembly comprising:
a hollow shaft which is rotatable about a rotational axis;
a rotor element coaxial to and surrounding the hollow shaft, wherein the rotor element rotates and/or can rotate together with the hollow shaft;
contact regions and spacing regions formed in a circumferential direction about a rotational axis between an outer periphery of the hollow shaft and an inner periphery of the rotor element,
wherein the rotor element is arranged to contact the hollow shaft in the contact regions and be spaced from the hollow shaft in the spacing regions; and
a conduction tube arranged in a cavity of the hollow shaft to be coaxial to the hollow shaft and to the rotor element and configured to conduct a cooling fluid.

29. The electric machine as claimed in claim 28,
wherein to generate a magnetic field, the rotor assembly has a first end winding and a second end winding which are arranged on end face regions of the rotor element,
wherein the electric machine has a first collection container for collection and distribution of cooling fluid to the first and second end windings and a flow channel for conduction of cooling fluid into the first collection container,
wherein the flow channel is arranged radially outside the rotor assembly and extends in an axial direction, and
wherein the first collection container has multiple container openings through which the cooling fluid can flow onto the first and second end windings.

30. A vehicle comprising:
an electric machine comprising:
a rotor assembly comprising:
a hollow shaft which is rotatable about a rotational axis;
a rotor element coaxial to and surrounding the hollow shaft, wherein the rotor element rotates and/or can rotate together with the hollow shaft;
contact regions and spacing regions formed in a circumferential direction about a rotational axis between an outer periphery of the hollow shaft and an inner periphery of the rotor element,
wherein the rotor element is arranged to contact the hollow shaft in the contact regions and be spaced from the hollow shaft in the spacing regions; and
a conduction tube arranged in a cavity of the hollow shaft to be coaxial to the hollow shaft and to the rotor element and configured to conduct a cooling fluid.
